(19) United States
(12) Patent Application Publication
(10) Pub. No.: US 2004/0066457 A1
(43) Pub. Date: Apr. 8, 2004

(54) System and method for remote controlled photography

(76) Inventors: D. Amnon Silverstein, Mountain View, CA (US); Pere Obrador, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/263,717

(22) Filed: Oct. 4, 2002

(51) Int. Cl. H04N 5/232

(52) U.S. Cl. 348/211.3; 348/211.99; 348/207.1

(57) ABSTRACT

Using a joint video and still image pipeline technology, a network may be deployed through the Internet so that a user may acquire high resolution photographs using a handheld device and a remote camera. The remote device may also include an identification tag embedded with the user's personal information, so that the remote camera may identify the user in the photographs by reading the identification tag. The remote camera may optionally annotate the photographs, which may be sent to the user through the network.

### CROSS-REFERENCE TO RELATED PATENT APPLICATIONS

This application is related to U.S. patent application Ser. No. 10/023,951, filed Dec. 21, 2001 (Attorney Docket No. 10007843-1), entitled “REMOTE HIGH RESOLUTION PHOTOGRAPHY AND VIDEO RECORDING USING A STREAMING VIDEO AS A VIEW FINDER” to Pere OBRADOR, et al., the subject matter of which is herein incorporated by reference.

### TECHNICAL FIELD

The technical field relates to camera systems, and, in particular, to remote controlled photography.

### BACKGROUND

With advancements in telecommunications, remote photography utilizing electronic remote devices becomes increasingly desirable. A person often finds a scene interesting or a moment worth remembering, only to discover that either no camera is available to capture the image or he/she is not in the best position to take the picture.

Remote photography is currently available in limited circumstances. For example, theme parks normally provide electronic photography systems for capturing images of customers participating in rides or events with digital cameras. The images are later sent to the customers through a network after verification of customer information and/or payment information. However, the electronic photography systems only randomly take pictures of the customers, i.e., the customers have no active control over the digital cameras regarding either timing or more advanced features, such as zooming. In addition, the process of customer verification and identification is currently accomplished manually.

### SUMMARY

A method for remote controlled photography includes using one or more photo-video acquisition devices as a view-finder to allow a video stream captured by the one or more photo-video acquisition devices to be viewed on a remote device, controlling the remote device to select a high resolution photograph from the video stream viewed on the remote device, and using a signal emitted from an identifying tag to identify a subject in the high resolution photograph.

In one embodiment, the one or more photo-video acquisition devices annotates the high resolution photograph. In another embodiment, a network server stores the video and the high resolution photograph, and either sends the video stream and the high resolution photograph to a user upon payment or posts the video stream and the high resolution photograph on a web page.

### DESCRIPTION OF THE DRAWINGS

The preferred embodiments of the method for remote controlled photography will be described in detail with reference to the following figures, in which like numerals refer to like elements, and wherein:

FIG. 1 illustrates an exemplary joint video and still image pipeline;

FIG. 2 illustrates an exemplary network and exemplary hardware components of a computer that may be used in connection with an exemplary method for remote controlled photography;

FIGS. 3(a) and 3(b) are flow diagrams illustrating how the exemplary joint video and still image pipeline of FIG. 1 enables a user to acquire remote high resolution photographs through the exemplary network of FIG. 2;

FIG. 3(c) is a flow diagram illustrating how the user may control a remote camera to acquire remote high resolution photographs through a point-to-point connection.

FIG. 4 is a flow chart illustrating the exemplary method for remote controlled photography;

FIG. 5 is another flow chart illustrating the exemplary method for remote controlled photography; and

FIG. 6 is yet another flow chart illustrating the exemplary method for remote controlled photography.

### DETAILED DESCRIPTION

Using a joint video and still image pipeline technology, a network may be deployed through the Internet so that a user may acquire high resolution photographs using a handheld device and a remote camera. The remote device may also include an identifying tag embedded with the user's personal information, so that the remote camera may identify the user in the photographs by reading the identifying tag. The remote camera may optionally annotate the photographs, which may be sent to the user through the network.

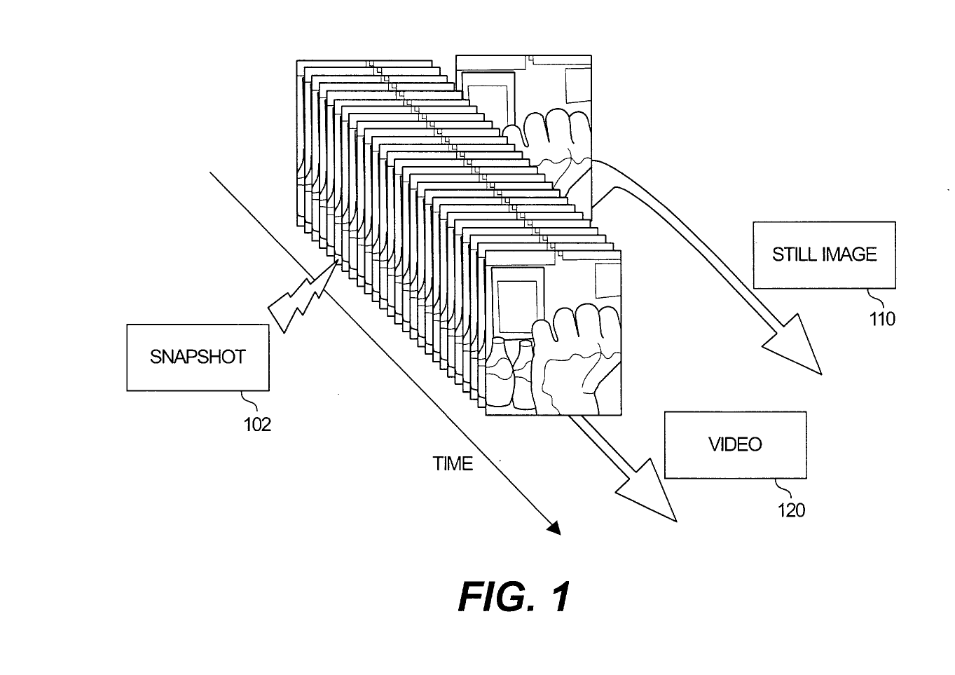

FIG. 1 illustrates an exemplary joint video and still image pipeline. The exemplary joint video and still image pipeline is capable of delivering videos 120 and still images 110, i.e., photographs, at the same time. For example, while a video stream 120 is being viewed or recorded, a snapshot 102 may be taken to generate the still image 110. The processing of the video stream 120 and the still images 110 may be in parallel.

The joint video and still image pipeline leverages existing processing from cameras, i.e., demosaicing, color processing, and image compression. Additionally, the joint video and still image pipeline takes advantage of existing expertise on digital video, i.e., video compression and video streaming and transcoding. The still images 110 typically have high resolution with, for example, 2-4 mega pixels. The high resolution still images 110 also have sophisticated demosaicing that leaves almost no demosaicing artifacts and high quality color correction that generates accurate color. On the other hand, the videos 120 typically have mid or low resolution with, for example, 640×480 resolution. In contrast to high resolution still images 110, the mid or low resolution videos 120 have fast demosaicing and fast color correction, which produces high frame rate. The video is then real time compressed and streamed with low delay and good error protection.

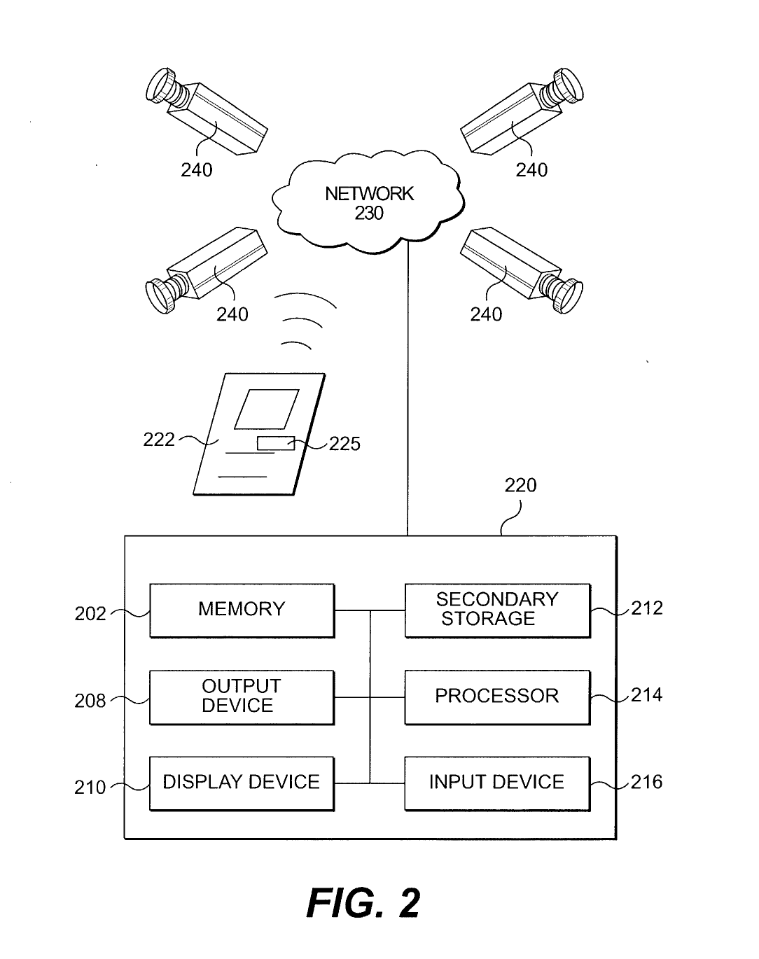

FIG. 2 illustrates an exemplary network 230 and exemplary hardware components of a computer 220 that may be used in connection with an exemplary method for remote controlled photography. The network 230, such as the Internet or other type of computer or phone networks, connects a user's remote devices 222, 220 with one or more photo-video acquisition devices 240. The remote devices 222, 220 may be a handheld device 222 or a desktop computer 220, whereas the photo-video acquisition devices 240 may be remote video cameras.

The computer 220 typically includes a memory 202, a secondary storage device 212, a processor 214, an input device 216, a display device 210, and an output device 208. The computer 220 is connected to the remote video cameras 240 through the network 230, and may send commands to the cameras 240 and receive a streaming video and image 120 from the cameras 240. The memory 202 may include random access memory (RAM) or similar types of memory. The secondary storage device 212 may include a hard disk drive, floppy disk drive, CD-ROM drive, or other types of nonvolatile data storage. The secondary storage device 212 may correspond with various databases or other resources. The processor 214 may execute applications or other information stored in the memory 202, the secondary storage 212, or received from the Internet or other network 230. The input device 216 may include any device for entering data into the computer 220, such as a keyboard, key pad, cursor-control device, touchscreen (possibly with a stylus), or microphone. The display device 210 may include any type of device for presenting visual image, such as, for example, a computer monitor, flatscreen display, or display panel. The output device 208 may include any type of device for presenting data in hard copy format, such as a printer, and other types of output devices including speakers or any device for providing data in audio form. The computer 220 can possibly include multiple input devices, output devices, and display devices.

Although the computer 220 is depicted with various components, one skilled in the art will appreciate that this computer can contain additional or different components. In addition, although aspects of an implementation consistent with the method for remote controlled photography and subject identification are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 220 to perform a particular method.

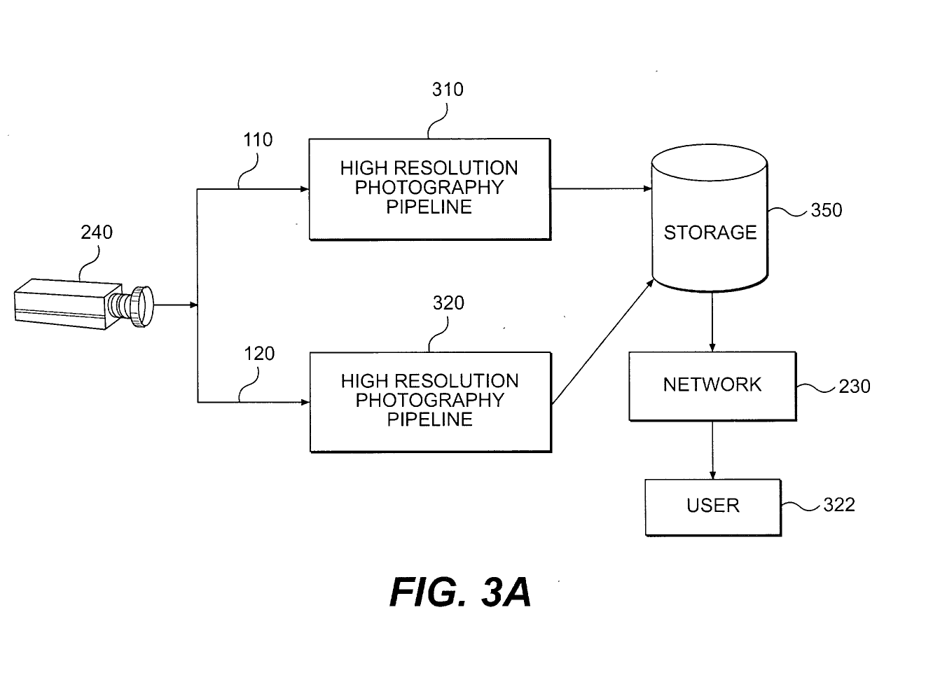

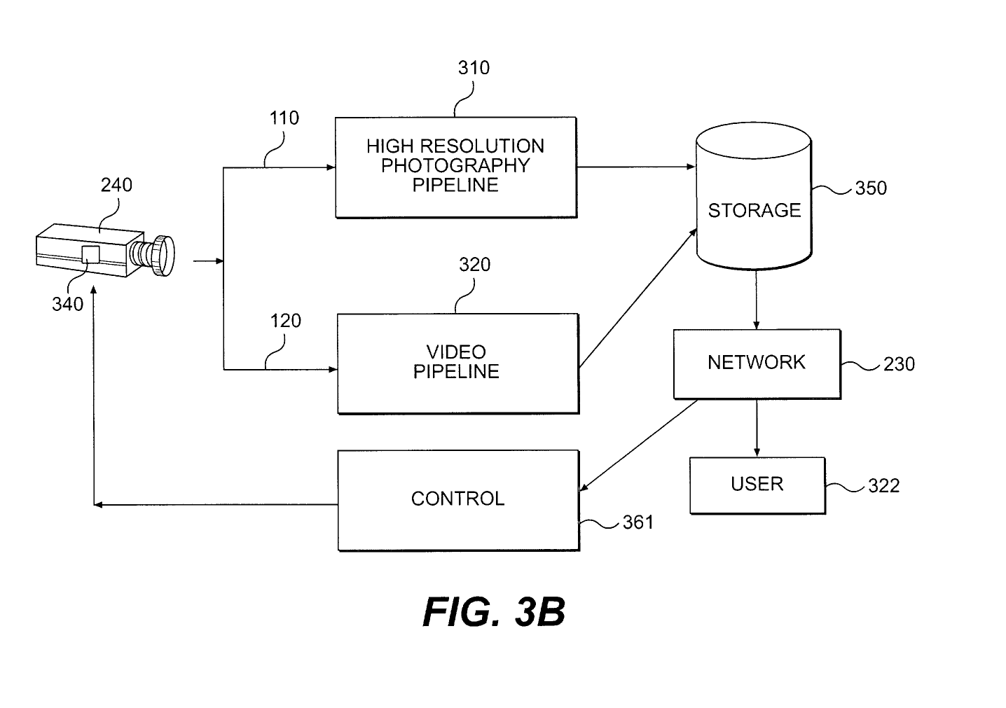

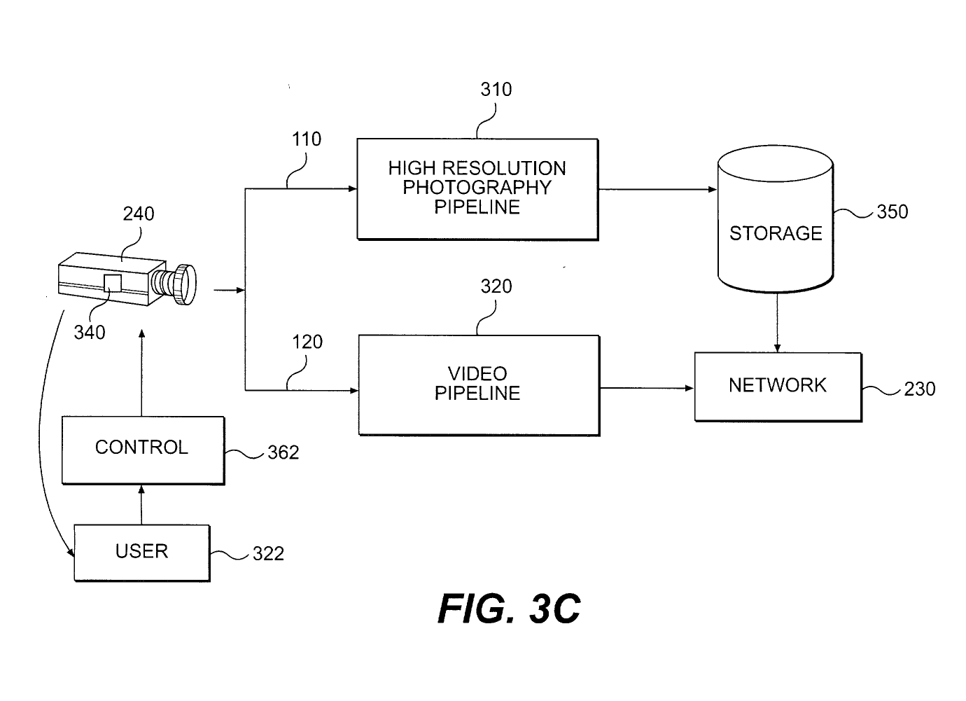

FIGS. 3(a) and 3(b) are flow diagrams illustrating how the exemplary joint video and still image pipeline enables a user to acquire remote high resolution photographs 110 through the network 230. Referring to FIG. 3(a), the network 230 enables a user 322 to connect to one of the photo-video acquisition devices 240, such as remote video cameras, in the network 230 and to receive a video stream 120 that is being captured by the remote camera 240. In other words, the user 322 may use the received video stream 120 transmitted by the remote camera 240 as a view-finder on the hand held device 222 or the desktop computer 220. When the user 322 perceives an interesting scene on the view-finder, the user 322 may take a high resolution photograph 110. If the cameras 240 are fixed, i.e., cannot be controlled or moved by any user 322, multiple users 322 can take high resolution photographs using a same camera 240 simultaneously.

The user 322 may use the remote camera 240 to view and record videos 120, as well as audio sounds. The user 322 may also acquire high resolution photographs 110, i.e., high resolution still images, at any time, using the video 120 streamed from the remote cameras 240 as a view-finder. The video 120 and high resolution photographs 110 may be processed and transmitted using the joint video and still image pipeline, 320 and 310, respectively. Joint transmission of video and high resolution photograph is described in detail, for example, in U.S. patent application Ser. No. 10/023,808 filed Dec. 21, 2001 (Attorney Docket No. 10007843-1), entitled “CONCURRENT DUAL PIPELINE FOR ACQUISITION, PROCESSING AND TRANSMISSION OF DIGITAL VIDEO AND HIGH RESOLUTION DIGITAL STILL PHOTOGRAPHS” to Pere OBRADOR, et al., which is incorporated herein by reference. Transmission of high resolution still images is described, for example, in U.S. Pat. No. 6,108,027, to Andrews, et. al., entitled “Progressive Still Frame Mode,” which is incorporated herein by reference.

After the videos 120 and/or the high resolution photographs 110 are acquired, the videos 120 and/or the high resolution photographs 110 may be saved in a storage 350 on a network server, such as a multimedia database connected to the network 230. The handheld devices 222 typically have bandwidth restrictions for video transmission, whereas the network 230 may process high bandwidth transmission with high speed connection. Therefore, while the user 322 receives low quality streaming video 120 on the handheld device 222, the video 120 stored in the storage 350 may be of higher quality than the streaming video 120 used as a view-finder. Alternatively, if the user 322 accesses the remote camera 240 from a desktop computer 220 with a high speed connection to the network 230, the streaming video 120 used as a view-finder may be of higher quality, due to the high bandwidth connection.

The videos 120 and/or the high resolution photographs 110 may be posted on a web page or may be sent to the user 322, for example, by e-mail, once payment has been secured. The user 322 may store the videos 120 and/or high resolution photographs 110 in a local secondary storage 212, and may print the high resolution photographs 110 on a printer.

Alternatively, a remote camera 240 may be controlled by a user 322, as illustrated in FIG. 3(b). In order to control one of the cameras 240 for remote photography, the user 322 may log onto the remote camera 240 and submit personal information, such as internet protocol address, e-mail address, and payment information, such as credit card number. Each remote camera 240 may be a microcomputer with a memory (not shown), a microprocessor 340, an input device (not shown), an output device (not shown), and a network connection (not shown), similar to the computer 220. The microprocessor 340 in the remote camera 240 may verify the user's payment information before granting access of control to the user 322. Verification of customer information is described, for example, in U.S. Pat. No. 6,222,646, to Maurinus, et. al., entitled “Electronic Photography System,” which is incorporated herein by reference.

In addition, the microprocessor 340 may implement a queue system for multiple users 322 to control the same camera 240. With the queue system, only after a previous user 322 logs off the camera 240, may another user 322 log onto the same camera 240 and exercise control 361. The control 261 may include tilting the remote camera 240 up or down, turning the camera 240 to the left or right, re-focusing the camera 240, or zooming the camera 240. The microprocessor 340 also controls motors in the remote camera 240 to perform the control commands received from the user 322.

FIG. 3(c) is a flow diagram illustrating how the user 322 may control the remote camera 240 to acquire remote high resolution photographs 110 through a point-to-point connection, such as a direct wire connection, a infra-red remote control, or a telephone network. The user 322 typically connects to the remote camera 240 and receives low resolution video 120 through a communication channel, such as a direct wire connection, a infra-red channel, or a telephone network channel, which are well known in the art. The user 322 may also send control commands 362 to the remote camera 240 through a same or a different communication channel. After high resolution photographs 110 are acquired, the photographs 110 may be sent to the user 322 directly through similar channels or through the network 230.

As one example, in a mobile environment, a user 322 may use a handheld device 222, such as a cell phone or a handheld computer, to control and acquire high resolution photographs 110 using one of the remote cameras 240 in the network 230. The cameras 240 may be specially positioned to acquire from a wide angle pictures of, for example, a theme park, so that users 322 may acquire high resolution pictures 110 of themselves in the theme park using a streaming video 120 obtained from the remote cameras 240 as a view-finder. The high resolution photographs 110 may later be posted on a web page or emailed to the users 322 upon payment.

In another embodiment, the handheld device 222 may include identifying tags 225 (shown in FIG. 2) embedded with user's personal information, such as contact information and email address. The identifying tags 225 may be passive radio tags or tags that emits signals for identification. When the remote camera 240 is used by multiple users 322 to take photographs 110, or when the remote camera 240 takes random photographs, for example, at a theme park, the remote camera 240 may read the identifying tags 225 on the handheld device 222 and identify the subject, i.e., users 322, in the photographs 110. The identifying tags 225 may also be located on the subject itself. After identifying the users 322 in the photographs 110, the microprocessor 340 may annotate the photographs 110 automatically. For example, if a photograph 110 is taken at a zoo, the microprocessor 340, may annotate the photograph 110 as “John at National Zoo on Aug. 2, 2002.” After verifying the user's payment information, the microprocessor 340 may email the photographs 110 to the users 322 through the network 230 or post the photographs 110 on a web page.

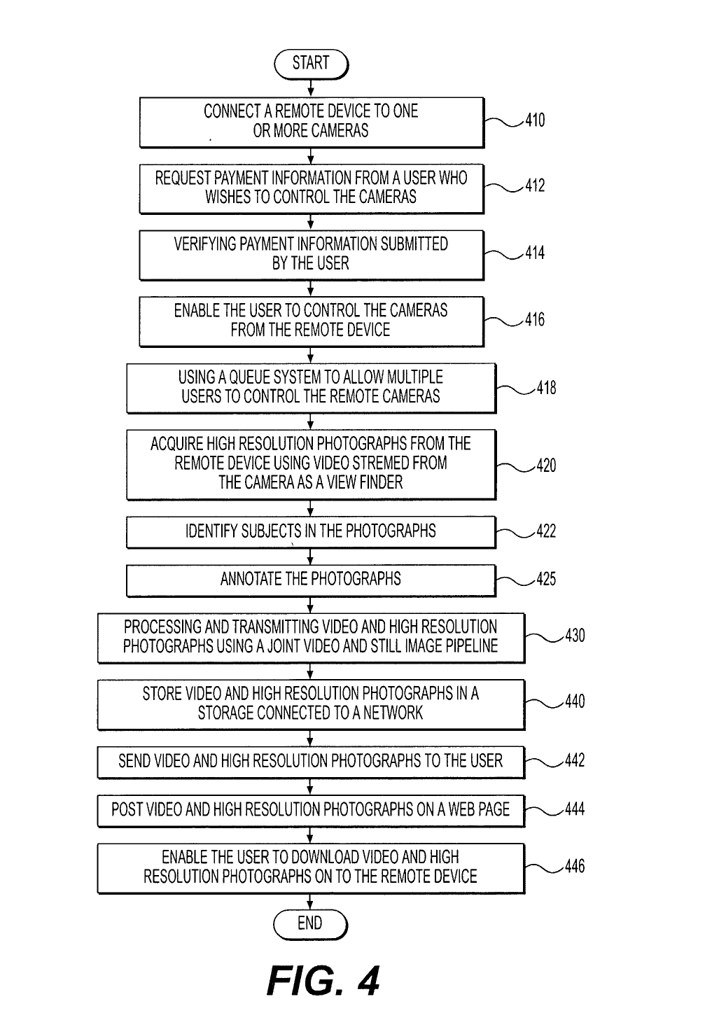

FIG. 4 is a flow chart illustrating an exemplary method for remote controlled photography. Step 410 involves connecting a remote device of the user 322, such as a handheld device 222 or a desktop computer 220, to one or more photo-video acquisition devices 240, such as remote video cameras, through a network 230 or other means, such as a direct wire connection, an infra-red remote control, or a network. In order to exercise control over one of the remote cameras 240, the user 322 may provide payment information to the remote camera 240, step 412. After a microprocessor 340 in the remote camera 240 verifies the payment information submitted by the user 322, step 414, the user 322 may control the remote camera 240 from the remote device, step 416. The microprocessor 340 may implement a queue system to allow multiple users 322 to control a same remote camera 240 in turn, step 418.

Next, the network 230 enables the user 322 to view the video 120 streamed from the remote camera 240 and to acquire a high resolution photograph 110 from the remote device, using the streaming video 120 captured by the remote cameras 240 as a viewfinder, step 420. If the same remote camera 240 is used by multiple users 322, or if the remote camera 240 takes random photographs 110, the remote camera 240 may identify the users 322 in the photographs 110 by reading the identifying tags 225 on the handheld devices 222 carried by the users 322, step 422. Optionally, the microprocessor 340 annotates the photograph 110 automatically, step 426.

Thereafter, the video 120 and the high resolution photograph 110 may be processed and transmitted in parallel using ajoint video and still image pipeline, step 430. Accordingly, whatever the user 322 perceives on the view-finder is exactly what the user 322 photographs, as in a single lens reflex (SLR) camera. The network 230 may store the video 120 and/or the high resolution photograph 110 in a storage 350 on a network server, step 440. The stored video 120 may be of higher quality than the streaming video 120 used as a view-finder. The video 120 and/or the high resolution photograph 110 may then be sent to the user 322 upon payment, step 442. Alternatively, the video 120 and/or the high resolution photograph 110 may be posted on a web page, step 444, which enables the user 322 to download to a remote device, such as a desktop computer 220, step 446.

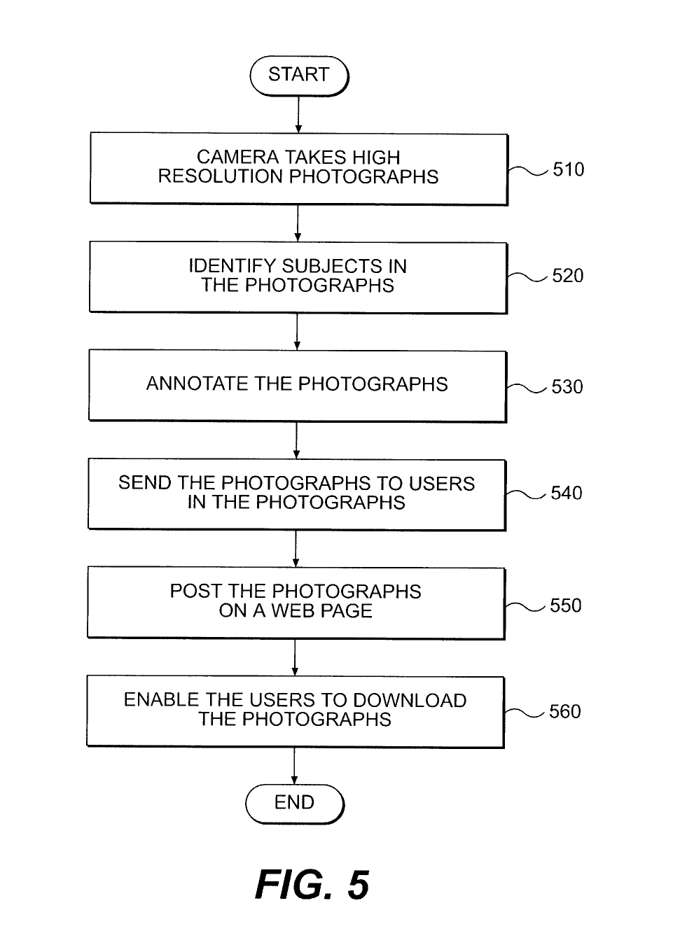

FIG. 5 is another flow chart illustrating the exemplary method for remote controlled photography. First, the remote camera 240 takes random photographs 110 of multiple users 322, for example, at a theme park, step 510. The remote camera 240 may identify the users 322 in the photographs 110 by reading the identifying tags 225 on the handheld devices 222 the users 322 are carrying, step 520. Optionally, the microprocessor 340 annotates the photographs 110 automatically, step 530. The photographs 110 may then be sent to the user 322 upon payment, step 540. Alternatively, the photographs 110 may be posted on a web page, step 550, which enables the user 322 to download to a desktop computer 220, step 560.

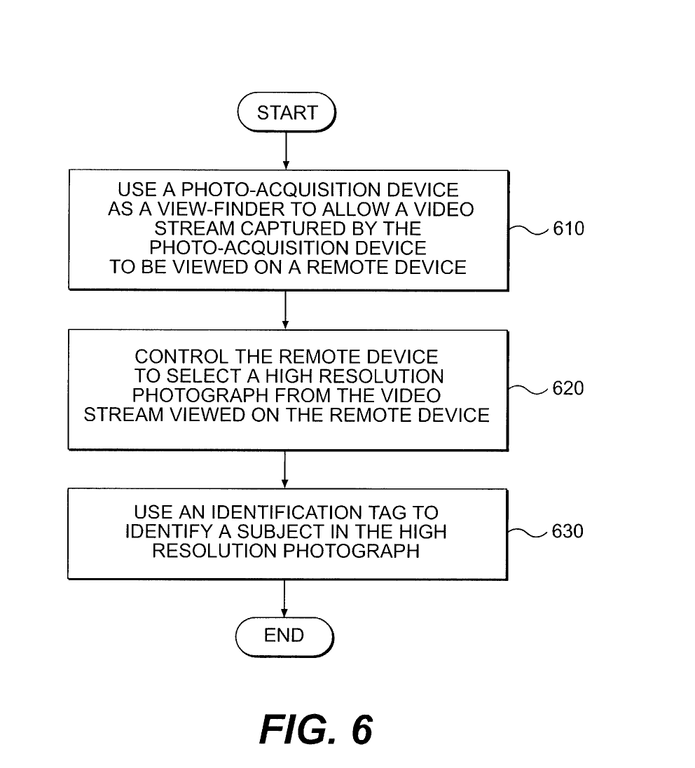

FIG. 6 is yet another flow chart illustrating the exemplary method for remote controlled photography. First, a user uses one or more photo-video acquisition devices 240 as a view-finder to allow a video stream 120 captured by the one or more photo-video acquisition devices 240 to be viewed on a remote device 222 (block 610). Next, the user 322 controls the remote device 222 to select a high resolution photograph 110 from the video stream 120 viewed on the remote device 222 (block 620). Then, the one or more photo-video acquisition devices 240 use an identifying tag 225 to identify a subject in the high resolution photograph 110 (block 630).

While the method and apparatus for remote controlled photography and subject identification have been described in connection with an exemplary embodiment, those skilled in the art will understand that many modifications in light of these teachings are possible, and this application is intended to cover any variations thereof.

What is claimed is:

1. A method for remote controlled photography, comprising:
using one or more photo-video acquisition devices as a view-finder to allow a video stream captured by the one or more photo-video acquisition devices to be viewed on a remote device;
controlling the remote device to select a high resolution photograph from the video stream viewed on the remote device; and
using an identifying tag to identify a subject in the high resolution photograph.

2. The method of claim 1, further comprising annotating the high resolution photograph.

3. The method of claim 2, wherein the high resolution photograph is annotated using the subject's personal information.

4. The method of claim 1, further comprising reading the identifying tag by the one or more photo-video acquisition devices.

5. The method of claim 1, wherein the identifying tag is located on the subject.

6. The method of claim 1, wherein the identifying tag is a passive radio tag.

7. The method of claim 1, wherein the identifying tag emits a signal, and wherein the one or more photo-video acquisition devices identify the subject in the high resolution photograph using the signal emitted from the identifying tag.

8. The method of claim 1, further comprising connecting the remote device to the one or more photo-video acquisition devices.

9. The method of claim 8, further comprising connecting the remote device to the one or more photo-video acquisition devices through a network.

10. The method of claim 8, further comprising connecting the remote device to the one or more photo-video acquisition devices through a point-to-point connection.

11. The method of claim 1, further comprising storing the video steam and the high resolution photograph in a storage on a network server.

12. The method of claim 1, further comprising posting the video stream and the high resolution photograph on a web page.

13. The method of claim 12, further comprising:
requesting payment information from a user who wishes to download the video stream and the high resolution photograph from the web page; and
enabling the user to download the video stream and the high resolution photograph.

14. The method of claim 1, further comprising sending the video stream and the high resolution photograph to the subject through a network.

15. An apparatus for remote controlled photography, comprising:
one or more photo-video acquisition devices capable of acquiring video streams and high resolution photographs; and
a remote device capable of connecting to the one or more photo-video acquisition devices through a network and acquiring the high resolution photographs, using videos streamed from the one or more photo-video acquisition devices as a view-finder,
wherein the one or more photo-video acquisition devices use an identifying tag to identify a subject in the high resolution photograph.

16. The apparatus of claim 15, wherein the photo-video acquisition devices are remote video cameras.

17. The apparatus of claim 15, wherein the one or more photo-video acquisition devices annotate the high resolution photographs.

18. A method for remote controlled photography, comprising:
acquiring a high resolution photograph by a photo-video acquisition device;
identifying a subject in the high resolution photograph by reading an identifying tag on a remote device carried by the subject, wherein the identifying tag contains the subject's personal information; and
sending the high resolution photograph to the subject through a network.

19. The method of claim 18, further comprising annotating the high resolution photograph.

20. The method of claim 18, further comprising storing the high resolution photograph in a storage on a network server.
